(19) United States
(12) Patent Application Publication
(10) Pub. No.: US 2008/0151918 A1
(43) Pub. Date: Jun. 26, 2008

(54) METHOD OF CORRELATING A MEDIA SESSION TO A SIGNALING SESSION

(75) Inventor: George Foti, Dollard des Ormeaux (CA)

Correspondence Address: ERICSSON CANADA INC.;PATENT DEPARTMENT, 8400 DECARIE BLVD., TOWN MOUNT ROYAL, QC, H4P 2N2, omitted

(73) Assignee: TELEFONAKTIEBOLAGET LM ERICSSON (PUBL), Stockholm (SE)

(21) Appl. No.: 11/615,506

(22) Filed: Dec. 22, 2006

(51) Int. Cl. H04L 12/56

(52) U.S. Cl. 370/410; 370/392

(57) ABSTRACT

A user terminal uses the Session Initiation Protocol (SIP) to establish a Real Time Streaming Media (RTSP) media session with a media content server. An application server, which establishes the RTSP media session, links the RTSP media session to the corresponding SIP session. Once the RTSP session is set up and linked to the SIP session, the media content server streams the media content to the user terminal.

### BACKGROUND

The present invention relates generally to methods of managing media sessions, and particularly to methods of streaming media to user terminals.

The IP multimedia subsystem (IMS) provides a common, standardized architecture and interface for providing IP services to mobile subscribers. IMS uses the Session Initiation Protocol (SIP) as the service control protocol, and thus, allows network operators to offer a wide array of applications and services to their subscribers.

One such service is Internet Protocol Television (IPTV). IPTV is a system in which a media content provider streams digital television service to a subscriber. Typically, IPTV is provided to residential subscribers in conjunction with Video on Demand (VoD), and may be bundled with other Internet services such as Web access, Voice over IP (VoIP), and mobile voice services. However, IMS networks will also allow the media content providers to stream media to the cellular telephones and Personal Digital Assistants (PDAs) of mobile subscribers as well.

To receive IPTV, a User Terminal (UT), such as a Set Top Box (STB), employs SIP to establish a Real Time Streaming Protocol (RTSP) session. Once the RTSP session is established, a media content server (MCS) delivers the IPTV media to the user. Currently, the SIP signaling session is not linked to the RTSP media session it creates. This makes reliable identification and authentication of the user difficult, and prohibits the correlation of accounting information with the user for billing purposes.

### SUMMARY

The present invention links a Real Time Streaming Protocol (RTSP) media session that streams media content to a User Terminal (UT) to a Session Initiation Protocol (SIP) session used to set up the RTSP media session. Linking the RTSP media session to the SIP session used to set up the RTSP session allows network operators to associate media transactions with users based on user information that is maintained during the signaling session. Such linking permits the network operators to more accurately identify users to be charged for media transactions, reconcile accounting records, and detect fraud.

In one embodiment, the UT comprises a controller, memory, and communication ports to communicate with an Application Server (AS) and a Media Content Server (MCS). The AS, which establishes and links the RTSP media sessions to the SIP session, also comprises a controller, memory, and communication ports to communicate with the UT and the MCS. The AS may initially perform the linking functions when establishing the RTSP media session. The AS uses a correlation value provided by the MCS to correlate the RTSP session, and the RTSP transactions in the RTSP session, to the SIP session. The AS stores the correlation between the RTSP and SIP sessions in memory, and uses it to identify and/or authenticate a user, bill the user, and reconcile new SIP sessions with existing RTSP sessions and new RTSP sessions with existing SIP sessions.

The UT exchanges SIP messages with the AS to establish the RTSP media session, and receives streaming media from the MCS. In one embodiment, the UT may also receive correlation information produced when the AS links the RTSP session to the SIP session. This information, which may include the correlation value, can be used by the UT and/or AS to reconcile subsequently established SIP sessions to existing RTSP sessions.

### BRIEF DESCRIPTION OF THE DRAWINGS

FIG. 1 illustrates a network used to transfer media to a User Terminal (UT) according to one embodiment of the present invention.

FIG. 2A illustrates a block diagram of a UT configured according to one embodiment of the present invention.

FIG. 2B illustrates an Application Server (AS) used to control media streams according to one embodiment of the present invention.

FIG. 3 illustrates one method of correlating the RTSP media session to the SIP session used to set up the RTSP media session.

FIG. 4 is a call flow diagram that illustrates a call flow according to one embodiment of the present invention.

FIG. 5 illustrates a signaling message configured to carry data according to one embodiment of the present invention.

FIGS. 6A-6B illustrate an exemplary method of updating the correlation between the RTSP media session to the SIP session used to set up the RTSP media session.

FIG. 7 is a call flow diagram that illustrates a call flow according to another embodiment of the present invention.

### DETAILED DESCRIPTION

The present invention uses a Session Initiation Protocol (SIP) signaling session as the session control protocol to establish a Real Time Streaming Protocol (RTSP) media session, and then links the RTSP session to the SIP signaling session used to set up the RTSP session. Other session control protocols could also be used. A User Terminal (UT) sends a SIP message to an application server to establish an RTSP session between the UT and a media content server. Establishing the RTSP session produces an RTSP session ID that identifies the user's media session. The application server may use the RTSP session ID to link the RTSP session to the SIP signaling session, and store that correlation link value in memory.

Correlating the RTSP session to the SIP session allows network operators to perform functionality not currently available with conventional systems. By way of example, the SIP message used to create the RTSP session includes the user's identification. Correlating the RTSP and SIP sessions facilitates cross-referencing the SIP user information to the RTSP media information. This allows network operators to apply accounting information related with the media session to the user that requested the media.

Further, the application server can identify the user by referencing the saved SIP information based on the correlation value. Thus, correlating the information in two sessions would also allow network operators to more accurately identify and authenticate a user. Additionally, SIP requires that a user be authenticated prior to sending SIP messages. Thus, the fact that the application server has already cached SIP information for the user implicitly authenticates the user in subsequent SIP and RTSP transactions.

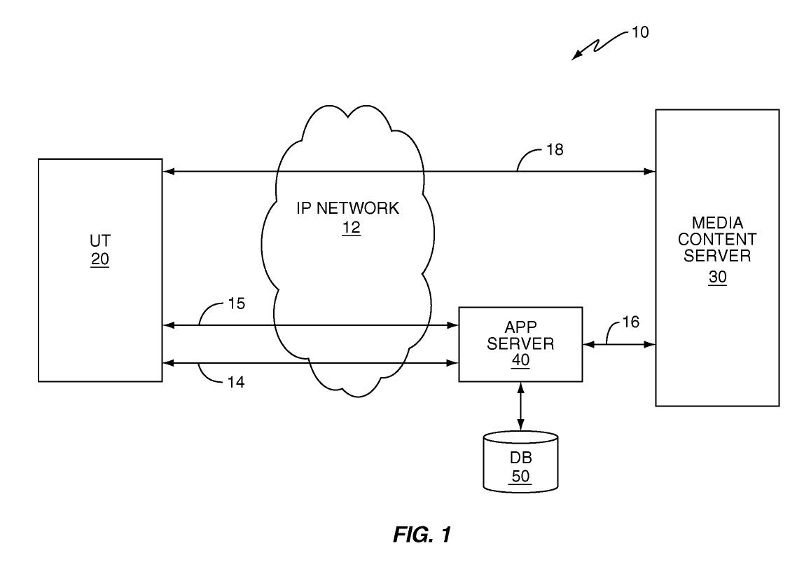

Turning now to the drawings, FIG. 1 illustrates a network infrastructure suitable for use in one embodiment of the present invention. It should be noted that FIG. 1 illustrates a network that includes only some of the entities and communication links used to deliver Internet Protocol Television (IPTV) services to a subscriber. Those skilled in the art should realize that this is for illustrative purposes only, and that network 10 may include additional or alternative entities and communication links appropriate to deliver any type of media to a user terminal.

Network 10 comprises an IMS backbone 12 that communicatively connects a UT 20, a Media Content Server (MCS) 30, and an Application Server (AS) 40. AS 40 may further connect to a database (DB) 50 that stores information specific to a user of the UT 20. Such information includes, but is not limited to, accounting/billing information and user profile information.

Signaling Link (SL) 14 and Transport Layer Security (TLS) link 15 communicatively connect the UT 20 and the AS 40, while Media Link (ML) 18 communicatively connects the UT 20 and the MCS 40. SL 14 comprises a two-way connection that carries SIP signaling messages or other session control messages between the UT 20 and the AS 40. TLS link 15 comprises a Transport Security Layer/Transmission Control Protocol (TLS/TCP) connection that carries RTSP transaction messages between the UT 20 and the AS 40. As described in more detail later, the AS 40 uses SIP signaling messages communicated over the SL 14 to establish an RTSP media session by communicating RTSP messages to the MCS 30 over link 16. AS 40 then correlates information from the SIP signaling messages to information associated with the established RTSP session.

Media Link 18 may comprise a Real Time Protocol (RTP) connection that carries packets of data between the MCS 40 and the UT 20. As is known in the art, RTP connections are capable of carrying any data having real-time characteristics, such as interactive audio and video. Thus, once the RTSP media session is established, the MCS 30 may transmit video and/or audio to the UT 20 over ML 18.

The process of initially establishing TLS/TCP and RTP type connections is well known in the art. Therefore, no detailed discussion of that process is presented here. It is sufficient to understand that the SL 14, the TLS link 15, and/or ML 18 may be established whenever the UT 20 attempts to negotiate an IMS control channel. Typically, this might occur when a user provides power to the UT 20 (e.g., whenever a user turns the UT 20 to “on”).

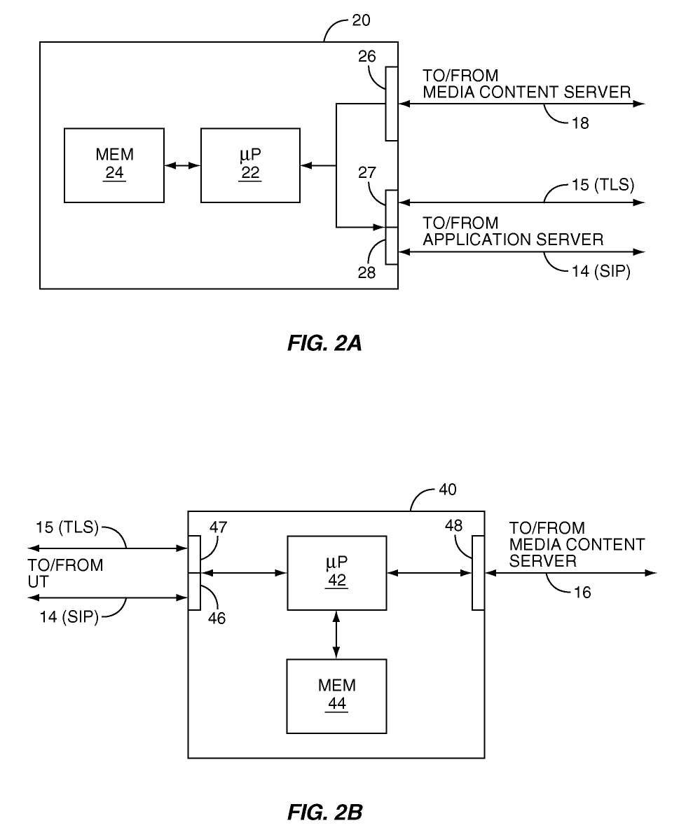

FIGS. 2A and 2B are block diagrams that illustrate some of the components of UT 20 and AS 40, respectively. UT 20 is a device that, in one embodiment, connects to a user's TV set (not shown). UT 20 comprises a controller 22, memory 24, a first port 26 to receive streaming media from MCS 30, and a second port 27 to communicate RTSP transaction messages with the AS 40, and a third port 28 to communicate SIP signaling messages with the AS 40. Examples of such UTs 20 include, but are not limited to, Set Top Boxes (STBs) that are used in conjunction with cable and/or satellite television. In network 10 of FIG. 1, UT 20 comprises a computing device that provides two-way communication with the MCS 30 and the AS 40. Particularly, controller 22 exchanges RTSP transaction messages and SIP signaling messages with the AS 40 over ports 27, 28, respectively, and media packets with the MCS 30 over port 26.

Generally, to initiate a media session such as an IPTV media session, controller 22 generates and sends a SIP INVITE message to the AS 40 over port 28. The AS 40 then establishes an RTSP media session, and links the established RTSP media session to the SIP session. This linking process produces correlation information that the UT 20 may receive from AS 40 in a return message. The controller 22 may store this correlation information in memory 24 for use in subsequent SIP messages to the AS 40.

AS 40 comprises a controller 42, memory 44, a first port 46 and a second port 47, and a third port 48. Controller 42 generates and sends RTSP transaction messages to the MCS 30 over port 48 responsive to the SIP signaling messages received from the UT 20 over the first port 46 (e.g., the SIP INVITE). Controller 42 also receives RTSP transaction messages from MCS 30 over port 48, and communicates RTSP transaction messages with the UT 20 over port 47. The transaction messages received from MCS 30 and communicated with the UT 20 may include information that the controller 42 can use to link the RTSP session to the SIP signaling session used to set up the RTSP media session.

In one embodiment, for example, the AS 40 receives an RTSP session ID from the MCS 30 during the set up of the RTSP media session. The controller 42 correlates the RTSP session ID to the SIP session using, for example, information included with the SIP INVITE message previously received from the UT 20. The AS 40 may then store the resultant correlation in memory 44. The AS 40 may employ this correlation to identify and/or authenticate the user, to bill the user for media services, to reconcile existing RTSP sessions with newly established SIP sessions, and to reconcile charging records generated at the AS 40 and MCS 30. AS 40 may also send the correlation information to the UT 20 for storage in memory 24, as previously stated.

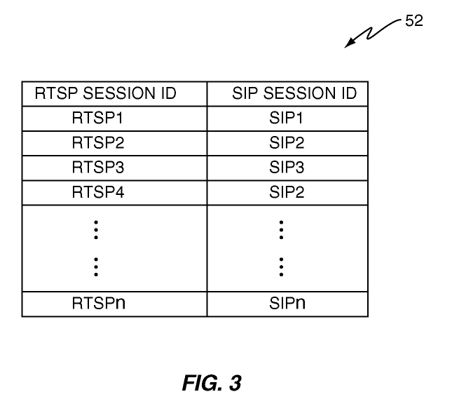

FIG. 3 illustrates an exemplary table 52 that could be used to correlate the RTSP media session information to the SIP session information. Table 52 may be stored at the AS 40, or at DB 50 and accessed by AS 40. In this embodiment, table 52 comprises a column that stores the RTSP session ID and a column that stores the corresponding SIP session ID. While not explicitly shown in this Figure, table 52 might also store other information including, but not limited to, the user ID and the URL associated with the RTSP media session. More than one RTSP session ID may be linked to the same SIP session ID. For example, the media sessions identified by RTSP2 and RTSP 4 are both linked to the signaling session identified by SIP2. However, each RTSP session ID may be linked to only one SIP session ID. Thus, AS 40 might employ the RTSP session ID as an index into table 52.

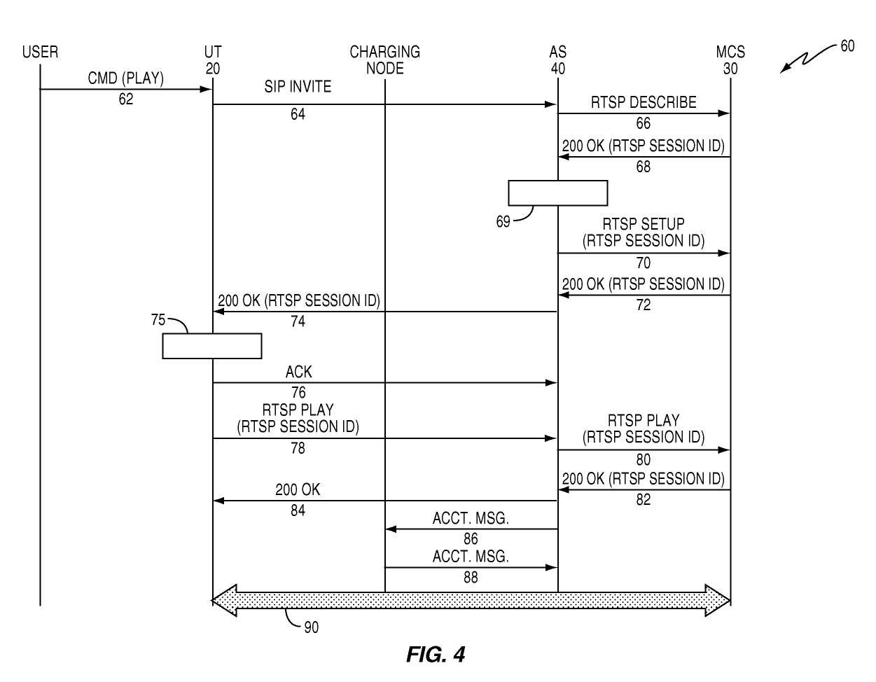

FIG. 4 is a call flow 60 illustrating how the present invention might initially link an RTSP media session to the SIP session. Those skilled in the art will appreciate that other entities may exist between the UT 20, the MCS 30, and the AS 40 that receive, interact, and forward the various messages. However, for purposes of clarity and ease of discussion, these entities are not described here.

Call flow 60 of FIG. 4 begins when a user issues an RTSP command from a remote control, such as “PLAY,” to start watching a movie (line 62). Such scenarios are common, for example, in VoD applications. Upon receipt of the PLAY command, the UT 20 sends a SIP INVITE message to the AS 40 via interface 14. The SIP INVITE message may include, inter alia, information that identifies the user, a SIP session ID, and a Uniform Resource Locator (URL) that identifies a particular MCS 30 and/or media program being requested by the user (line 64). The AS 40 may extract this information for storage in local memory 44, and generates and sends an RTSP DESCRIBE command to the identified MCS 30 (line 66). In response, the MCS 30 returns a confirmation message to the AS 40 (line 68). The confirmation message may be, for example, a 200 OK message.

The 200 OK message returned by the MCS 30 may be, for example, a Session Description Protocol (SDP) message that contains information relevant to the RTSP session being established. Such information includes, but is not limited to, the RTSP session ID. The AS 40 can use this data to link the RTSP session to the SIP session used to set up the RTSP session. For example, the AS 40 may correlate the RTSP session ID to the information extracted from the SIP INVITE message, and save the correlated information in memory 44 (box 69). This allows the AS 40 to identify the SIP session originator (i.e., the user that created the RTSP session) if the SIP session terminates inadvertently. It also allows network operator to correlate the billing and accounting information that may be stored on disparate servers, as well as authenticate the user.

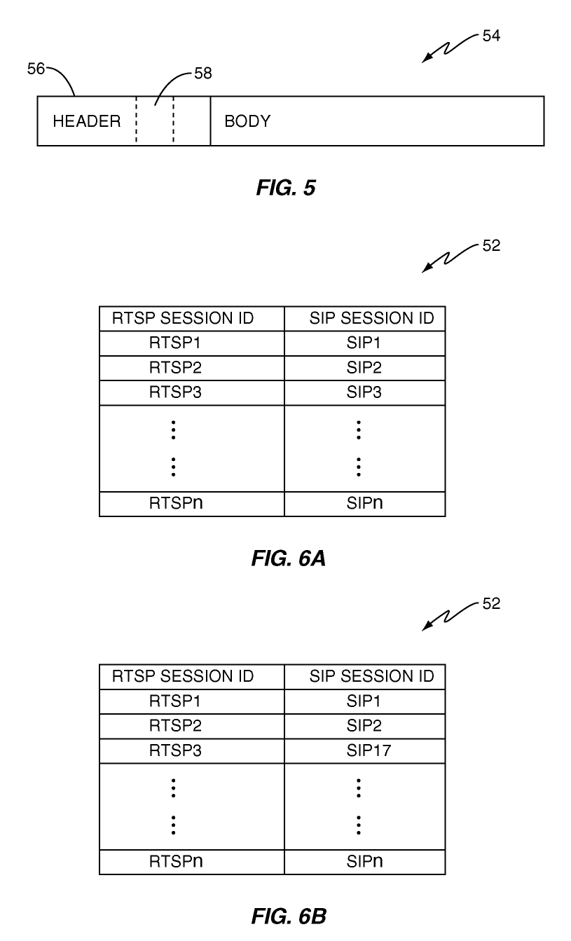

The AS 40 then sends an RTSP SETUP message to the MCS 30 to set up the RTSP media session (line 70), receives a 200 OK message in response (line 72), and returns a 200 OK message to the UT 20 (line 74). The 200 OK message sent to the UT 20 may include the information that the AS 40 used to link the RTSP session and the SIP session. As seen in FIG. 5, the AS 40 in this embodiment inserts an RTSP session ID 58 into the header 56 of the 200 OK message 54; however, the AS 40 might also include other information describing the correlation between the RTSP session and the SIP session.

Upon receipt of the 200 OK message, the UT 20 extracts the correlation information and uses that information to link the RTSP session to the SIP session (FIG. 4—box 75). For example, the UT 20 might correlate the returned RTSP session ID to the SIP session used to create the RTSP media session. The UT 20 may then store this correlation information in a local copy of table 52 for use in populating subsequent SIP messages to the AS 40 with the corresponding RTSP session ID.

The UT 20 then sends an acknowledgment (ACK) to the AS 40 (line 76), and the RTSP PLAY command to the AS 40 (line 78). The UT 20 includes the RTSP session ID in the header of the RTSP PLAY command to allow the AS 40 to locate the appropriate MCS 30. The AS 40 issues an RTSP PLAY command to the identified MCS 30 (line 80) and receives a 200 OK message in return (line 82). The AS 40 then returns a 200 OK message to the UT 20 (line 84) and generates and sends appropriate billing messages to effect user billing (lines 86, 88). The UT 20 then receives the streaming media from the MCS 30 (line 90).

The AS 40 stores the correlation information used to link the RTSP media session with the SIP session used to set up the RTSP session. The AS 40 may access this information by using the RTSP session ID included with the RTSP PLAY command as an index to locate its associated SIP session information stored in memory 44. Once determined, the AS 40 may communicate user identification information in billing messages to the DB 50, or some other remote network entity.

Those skilled in the art will appreciate that the SIP session used to set up the RTSP session may terminate. Such a scenario might occur, for example, responsive to a SIP session timeout after the initial RTSP media session has been established. Timeouts occur, for example, if the SIP session has been left idle for a predetermined period. Another reason for SIP session termination is due to policy considerations. For example, network operators may assign a maximum time to which the SIP signaling session may be active. Once the maximum time has been exceeded, the SIP session is torn-down by the network.

Because conventional methods of streaming media do not link the RTSP session to the SIP session that created it, the AS 40 would reject subsequent RTSP commands from the UT 20 as invalid. The AS 40 would then have to teardown the existing RTSP media session and create a new RTSP media session responsive to a new SIP session initiated by the user. The linking performed by the present invention, however, avoids the need for teardown, and instead, allows the AS 40 and the UT 20 to establish a new SIP session and link it with the existing RTSP media session. This permits the AS 40 and UT 20 to revive the existing RTSP session.

FIGS. 6A and 6B illustrate how the AS 40 might correlate a new SIP session ID to an existing RTSP session ID in table 52. As seen in FIG. 6A, table 52 uniquely links “RTSP3” to “SIP3,” which is the session ID of SIP signaling session used to set up the RTSP media session. If the SIP session identified by “SIP3” is terminated for some reason (e.g., timeout or policy reasons), UT 20 would establish a new SIP session. Rather than tear down the existing RTSP session identified by “RTSP3,” however, AS 40 would simply correlate the existing RTSP media session to the new SIP session by updating the correlation information in table 52 to include the new SIP session ID. In FIG. 6B, for example, “RTSP3” is updated to reflect the new SIP session ID “SIP17,” which correlated the RTSP session ID to the new SIP session ID.

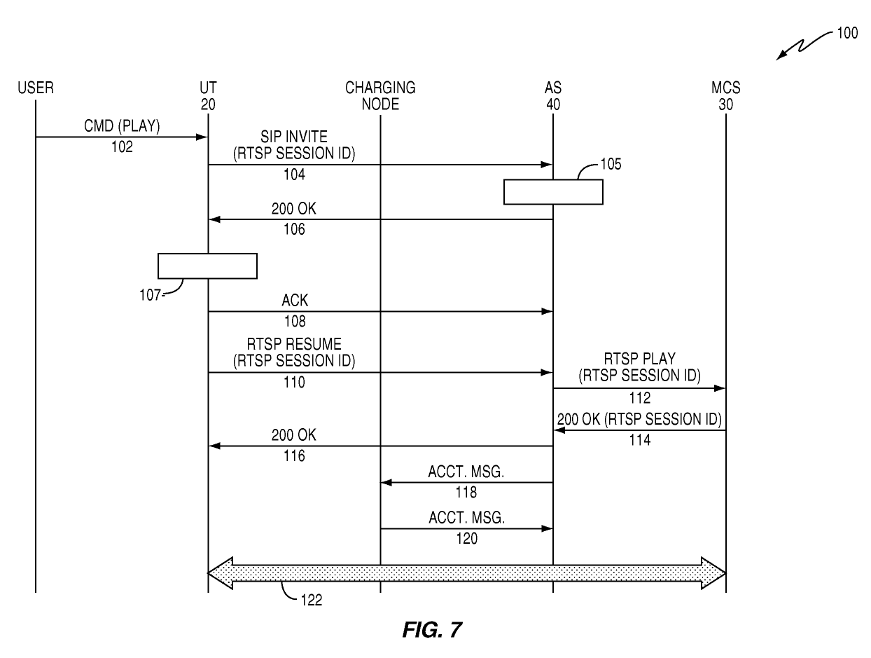

FIG. 7 is a call flow 100 illustrating how the present invention might revive an existing RTSP media session. As seen in FIG. 4, the user issues a PLAY command from a remote control (line 102) after the initial SIP session terminates. The UT 20 issues a new SIP INVITE message to the AS 40 (line 104), which includes the RTSP session ID previously stored in memory 24 when the RTSP media session was initially established. Rather than send RTSP DESCRIBE and SETUP messages to the MCS 30, however, the AS 40 uses the RTSP session ID received from the UT 20 as an index and updates the correlation information stored in memory 44 (box 105). Updating might include replacing the existing SIP session ID with the new SIP session ID received from the UT 20. AS 40 then returns a 200 OK message to the UT 20 (line 106). Upon receipt, the UT may update its own correlation information (box 107), and return an ACK from the UT 20 (line 108).

The UT 20 then issues an RTSP RESUME command (line 110) that includes the RTSP session ID in the header. In response, the AS 40 issues the RTSP PLAY command to the MCS 30 (line 112), receives a 200 OK message from the MCS 30 (line 114), and notifies the UT 20 (line 116). The AS 40 may then perform billing functions as previously described (lines 118, 120) and the media stream to the UT 20 is restored.

The previous embodiments illustrate a method of linking an RTSP media session to a SIP signaling session used to set up the RTSP media session. In those embodiments, the present invention used an RTSP session ID as a correlation value to effect that linking. Those skilled in the art should realize, however, that the use of the RTSP session ID is illustrative only. The present invention may use any token or value to correlate the RTSP session to the SIP session. Such suitable tokens and values include, but are not limited to, randomly generated tokens and values.

In addition, the previous embodiment illustrates the present invention in the context of IPTV. However, it should be appreciated that the present invention may be used to control and/or manage the resources for other types of streaming media.

The present invention may, of course, be carried out in other ways than those specifically set forth herein without departing from essential characteristics of the invention. The present embodiments are to be considered in all respects as illustrative and not restrictive, and all changes coming within the meaning and equivalency range of the appended claims are intended to be embraced therein.

What is claimed is:

1. A method of streaming media to a user terminal, the method comprising:
establishing a media session between a media content server and a user terminal; and
linking the media session to a signaling session that was used to establish the media session.

2. The method of claim 1 wherein linking the media session to the signaling session comprises correlating the media session to the signaling session using a correlation value.

3. The method of claim 2 wherein linking the media session to the signaling session further comprises using the correlation value to correlate one or more transactions associated with the media session to the signaling session.

4. The method of claim 2 wherein the correlation value comprises a Real Time Streaming Protocol (RTSP) session identifier associated with the media session.

5. The method of claim 4 wherein the signaling session comprises a Session Initiation Protocol (SIP) session and wherein correlating the media session to the signaling session comprises associating the RTSP session identifier with a SIP session identifier.

6. The method of claim 1 wherein linking the media session to the signaling session comprises storing correlation information at an application server to associate the media session with the signaling session.

7. The method of claim 6 further comprising communicating the correlation information to the user terminal.

8. The method of claim 7 further comprising linking the media session to a subsequent signaling session responsive to termination of a previous signaling session using correlation information received from the user terminal.

9. The method of claim 8 wherein linking the media session to a subsequent signaling session comprises updating correlation information stored at the application server associated with the media session.

10. The method of claim 6 further comprising using the correlation information to link two or more media sessions to the same signaling session.

11. The method of claim 6 further comprising using the correlation information to generate charging records to charge media transactions during the media session.

12. An application server to control a media stream to a user terminal, the application server comprising:
a first port configured to exchange session control messages with a user terminal during a signaling session;
a second port configured to exchange media messages with a media content server; and
a controller configured to:
establish a media session between the user terminal and the media content server responsive to receiving a session control message over the first port; and
link the media session with the signaling session based on correlation information received from the media content server over the second port.

13. The application server of claim 12 wherein the correlation information comprises a correlation value that links the media session to information derived from the session control messages.

14. The application server of claim 13 wherein the controller is configured to use the correlation value to link one or more media transactions associated with the media session to the signaling session.

15. The application server of claim 13 wherein the media session comprises a Real Time Streaming Protocol (RTSP) session and wherein the correlation value comprises a RTSP session identifier associated with the RTSP session.

16. The application server of claim 15 wherein the signaling session comprises a Session Initiation Protocol (SIP) session and wherein the controller is configured to correlate the RTSP session identifier with a SIP session identifier.

17. The application server of claim 12 wherein the controller is further configured to:
generate a media request message responsive to receiving the session control message over the first port;
transmit the media request message to the media content server over the second port; and
receive a media response message having the correlation information from the media content server over the second port.

18. The application server of claim 17 further comprising memory for storing the correlation information.

19. The application server of claim 17 wherein the controller is configured to transmit the correlation information to the user terminal.

20. The application server of claim 19 wherein the controller is further configured to link the media session with a subsequent signaling session responsive to termination of a previous signaling session using correlation information received from the user terminal.

21. The application server of claim 20 wherein the controller is configured to link the media session to the subsequent signaling session by updating correlation information stored at the application server and associated with the media session.

22. The application server of claim 17 wherein the controller is configured to link two or more media sessions to the same signaling session.

23. The application server of claim 17 wherein the controller is configured to generate charging records for media transactions during the media session based on the correlation information.

24. A user terminal for receiving streaming media from a media content server, the user terminal comprising:
a first port configured to exchange session control messages with an application server during a signaling session to establish a media session with the media content server;
a second port configured to receive a media stream from said media content server during said media session;
a controller configured to:
exchange session control messages with said application server to set up the media session; and
receive correlation information from said application server linking said media session with said signaling session when said media session is established; and
memory to store said correlation information.

25. The user terminal of claim 24 wherein the correlation information comprises a correlation value that links the media session to information derived from the session control messages.

26. The user terminal of claim 25 wherein the media session comprises a Real Time Streaming Protocol (RTSP) session and wherein the correlation value comprises a RTSP session identifier associated with the media session.

27. The user terminal of claim 26 wherein the signaling session comprises a Session Initiation Protocol (SIP) session and wherein the RTSP session identifier is linked with a SIP session identifier.

28. The user terminal of claim 25 wherein the controller is configured to link the media session to a subsequent signaling session responsive to termination of a previous signaling session using the stored correlation information.

29. The user terminal of claim 28 wherein the controller links the media session to a subsequent media session by updating the correlation information associated with the media session stored in memory at the user terminal.

30. The user terminal of claim 25 wherein the controller is further configured to link two or more media sessions to the same signaling session.

31. A method of establishing a media session, said method comprising:
establishing a signaling session with an application server;
exchanging session control messages with said application server to establish a media session with a media content server;
receiving correlation information from said application server linking said media session with said signaling session;
storing said correlation information in memory at said user terminal.

32. The method of claim 31 wherein said correlation information includes a correlation value that associates the media session with the signaling session.

33. The method of claim method of claim 32 wherein said media session comprises a Real Time Streaming Protocol (RTSP) session and wherein said correlation value comprises an RTSP session identifier.

34. The method of claim 33 wherein said signaling session comprises a Session Initiation Protocol (SIP) session and wherein the RTSP session identifier is linked with a SIP session identifier.

35. The method of claim 31 further comprising using the stored correlation information to link the media session to a subsequent signaling session responsive to termination of a previous signaling session.

36. The method of claim 35 wherein linking the media session to a subsequent media session comprises updating the correlation information associated with the media session stored in memory at the user terminal.

37. The method of claim 31 further comprising linking two or more media sessions to the same signaling session.
